(19) United States
(12) Patent Application Publication
(10) Pub. No.: US 2003/0168607 A1
(43) Pub. Date: Sep. 11, 2003

(54) Focused ion beam system enabling observation/machining of large sample

(76) Inventor: Katsumi Suzuki, Chiba (JP)

Correspondence Address: Adams & Wilks, 50 Broadway 31st Floor, New York, NY, 10004, US

(21) Appl. No.: 10/332,555

(22) PCT Filed: Feb. 27, 2002
(86) PCT No.: PCT/JP02/01820

(30) Foreign Application Priority Data
Mar. 19, 2001 (JP) 2001-78892

(51) Int. Cl. G21K 1/08; H01J 3/14

(52) U.S. Cl. 250/396 R

(57) ABSTRACT

A focused ion beam of the present invention can handle all regions of a sample by having an ion optical system arranged so that an irradiation center position of the ion beam comes to a location eccentric in a direction of one corner from a center of a rectangular sample chamber, making a sample chamber of a size that makes it possible to move a sample stage two-dimensionally in X and Y directions by such an extent that the ion irradiation position can cover a region spanning from one corner of the sample to a central section, and combining this with a sample rotating mechanism.

### TECHNICAL FIELD

The present invention relates to a focused ion beam device used in observation and processing of a sample.

### BACKGROUND ART

Focused ion beam processing for forming holes of a desired shape in the surface of a sample by sputter etching or gas assisted etching using a focused ion beam device as shown in FIG. 6, or irradiating a focused ion beam 2 while spraying source material gas from a gas gun 6 to carry out deposition, and obtaining a microscopic image by deflection scanning and irradiation of an ion beam 2 and detection of secondary charge particles emitted from the sample using a secondary charged particle detector 5 are widely used for correcting defects in a semiconductor device photo mask, and observation of a semiconductor wafer etc.

Reference numeral 1 in the drawings is an ion source, and ions are caused to be emitted by applying a voltage to an electrode lead out from this ion source. These ions are focused into a beam shape by an ion optical system 3, deflected by a deflector 4 and irradiated to desired locations on a sample 9. In processing using deposition, processing using sputter etching, or alternatively in obtaining a microscopic image, an ion beam is deflection-scanned by a deflector 4 so as to be irradiated at a specified region of a sample 9. Processing is carried out or image information is acquired for the irradiated region of the sample, but processing can not be handled by this deflection device when a wide region is involved. This case is dealt with by providing a mechanism to allow movement of a sample stage 7 upon which the sample 9 is mounted in three axial directions, namely X, Y and Z axis directions. A stage drive mechanism, in addition to these three axial drives, can also drive in five axial directions, adding rotational drive in a beam axis direction and inclined angle drive, or in six axial directions. Reference numeral 8 is charge neutralizer.

In this focused ion beam device, in order to make all regions of a rectangular sample of m×n, as shown in FIG. 5(A), the subject of processing or observation, it is necessary to move the sample over the entire sample surface to the position of the optical axis of the ion optical system constituting the center of observation. Therefore, as shown in FIG. 5(B), it is necessary to ensure in excess of double both the length and width of the sample, namely (2m+α)×(2n+α). Here α is a dimension required as clearance. In the case where a device or the like constituting a sample of the focused ion beam device is small this problem does not arise, but when items such as a semiconductor wafer or a mask or resist as a sample are made extremely large under the latest technological conditions, the drive range of a sample stage becomes large and it is necessary to provide a large sample chamber. Furthermore, this focused ion beam device irradiates an ion beam to a sample under vacuum conditions, and since it is necessary to make the ion beam optical system section and the sample chamber be in a vacuum state during use, a problem arises that due to this enlargement of the sample not only does the size of the sample chamber need to be enlarged, but also a vacuum device for evacuating this space must also be made large in size. This enlargement of the devices places a burden on the working efficiency because it is necessary to create a vacuum in a large volume sample chamber, as well as the enlargement introducing significant costs.

The object of the present invention is to solve the above described problems, that is, to provide a focused ion beam device available for a large sample while curbing enlargement of the focused ion beam device by providing comparatively small chamber.

### DISCLOSURE OF THE INVENTION

A focused ion beam device of the present invention can handle all regions of a sample by having an ion optical system arranged so that an irradiation center position of the ion beam comes to a place eccentric in a direction of one corner from the center of a rectangular sample chamber, making a sample chamber a certain size that makes it possible to move a sample stage two dimensionally in X and Y directions by such an extent that the ion irradiation position can cover a region spanning from one corner to the central position of the sample, and combining this with a sample rotating mechanism.

### BRIEF DESCRIPTION OF THE DRAWINGS

FIG. 1A is a drawing showing a rectangular sample divided into four regions.

FIG. 1B is a drawing showing range of stage movement for the case where the sample is placed with its longer side in a sideways direction.

FIG. 1C is a drawing showing range of stage movement for the case where the sample is placed with its shorter side in a sideways direction.

FIG. 2 is a drawing for describing space required in the case of the present invention with respect to sample dimensions.

FIG. 3 is a drawing for describing the case where a rotation mechanism is provided in a sample chamber and the case where the rotation mechanism is provided in a auxiliary chamber.

FIG. 4 is a flowchart describing work flow for an embodiment of the present invention.

FIG. 5 is a drawing for describing space required in the case of the related art with respect to sample dimensions.

FIG. 6 is a drawing showing the basic structure of a focused ion beam device.

### BEST MODE FOR CARRYING OUT THE INVENTION

The present invention has been conceived in order to respond to demand to enable irradiation of an ion beam to wide regions of a large sample without enlarging a device, and does not use the related art method where an ion beam irradiation position is made to handle all regions of a sample simply by causing the sample to move two dimensionally in X and Y directions inside a sample chamber, but instead all regions are handled, even if only a certain region of a sample is handled by only moving the sample two dimensionally in X and Y directions, by making the region a region spanning from a corner to a central region of the sample with the region not being the central part of the sample and adding rotation of the sample.

As described above, the device of the related art is also provided with a stage rotation drive, but since an installation position for an ion optical system is provided at a central part of a sample chamber, a region that can be handled by two dimensional movement in the X and y directions is a central region and this device can not cover the corners when two dimensional movement is limited, even if rotational drive is performed. Specifically, the basic concept of the present invention is the combination of causing an installation position of the ion optical system to be off center towards the corners with respect to the center of the sample chamber, and rotation of the sample. This off-center condition means that a region that can be covered, by two dimensional movement of the stage in the X and Y directions is not at the center section of the sample but a region spanning from a corner to the center.

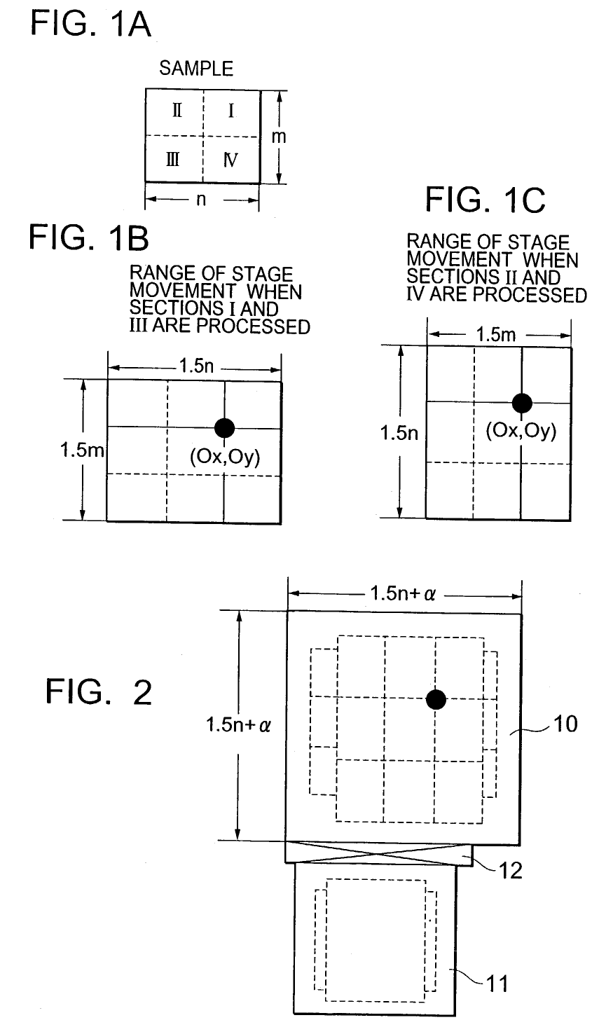

The case will now be considered where a rectangular sample of m×n is the subject. However, the relationship n>m is established. First of all, as shown in FIG. 1A, the surface of the sample is partitioned into four, regions I, II, III and IV having a size of 0.5n×0.5m are designated, and ion beam irradiation to each of the partitioned regions is considered. As shown in FIG. 1B and FIG. 1C, when regions I and III are irradiated, the sample is placed with its longer side in a sideways direction, while when regions II and IV are irradiated the sample is placed with its shorter side in a sideways direction. When regions I and III are irradiated, the sample is positioned at a lower left corner of the sample chamber. The optical axis of the ion optical system at this time (shown by a black circle) is required to reach the upper right corner of the regions I and III. If this position is represented by X, Y coordinates with the lower left corner of the sample chamber as the origin, the coordinates of the optical axis of the ion optical system (0x, 0y) must be such that 0x≧n, Oy≧m. Then, when the sample is moved to the upper right corner of the sample chamber by two dimensional X and Y direction movement of the stage, the central portion of the sample must reach the coordinate position of the optical axis of the ion optical system. Specifically, it is necessary for the coordinates (X1, Y1) of the upper right corner of the sample chamber to be such that X1≧1.5n, Y1≧1.5m, and for a relationship between coordinates of the optical axis of the ion optical system (Ox, Oy) and the coordinates of the upper right corner of the sample chamber (X1, Y1) to be X1−Ox≧n/2, Y1−Oy≧m/2.

Next, when regions II and IV are irradiated, the sample is placed with its shorter side in a sideways direction. When each of the regions II and IV are irradiated, the sample is positioned in the lower left corner of the sample chamber. The optical axis of the ion optical system at this time (represented by a black circle) must reach the upper right corner of the regions II and IV. If this position is represented by X, Y coordinates with the lower left corner of the sample chamber as the origin, the coordinates of the optical axis of the ion optical system (0x, 0y) must be such that 0x≧m, Oy≧n. Then, when the sample is moved to the upper right corner of the sample chamber by two dimensional X and Y direction movement of the stage, the central portion of the sample must reach the coordinate position of the optical axis of the ion optical system, which means that it is necessary for the coordinates (X1, Y1) of the upper right corner of the sample chamber to be such that X1≧1.5m, Y1≧1.5n, and for a relationship between coordinates of the optical axis of the ion optical system (Ox, Oy) and the coordinates of the upper right corner of the sample chamber (X1, Y1) to be X1−Ox ≧m/2, Y1−Oy≧n/2.

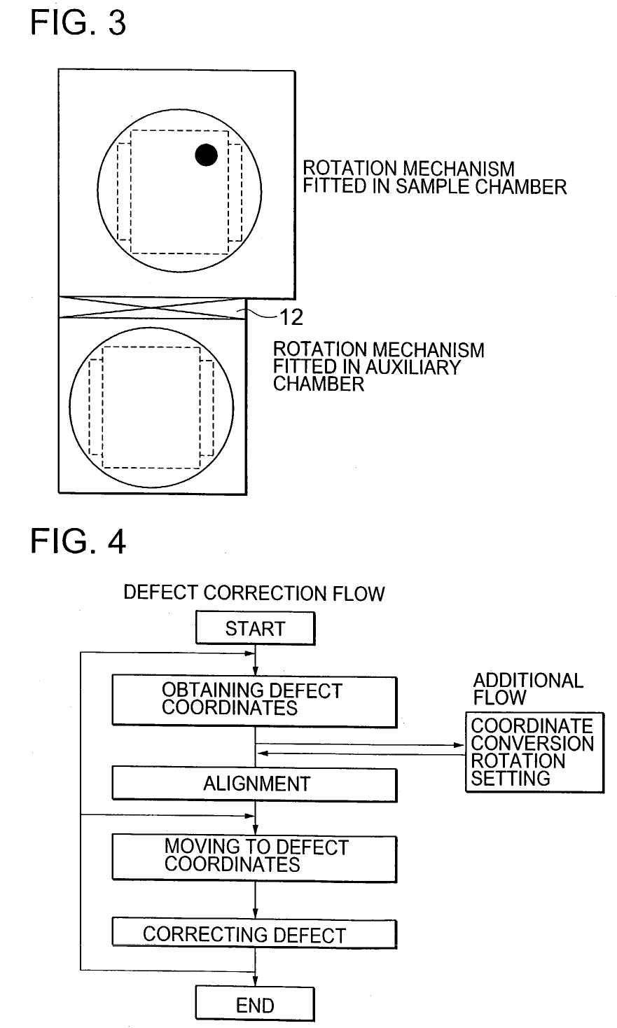

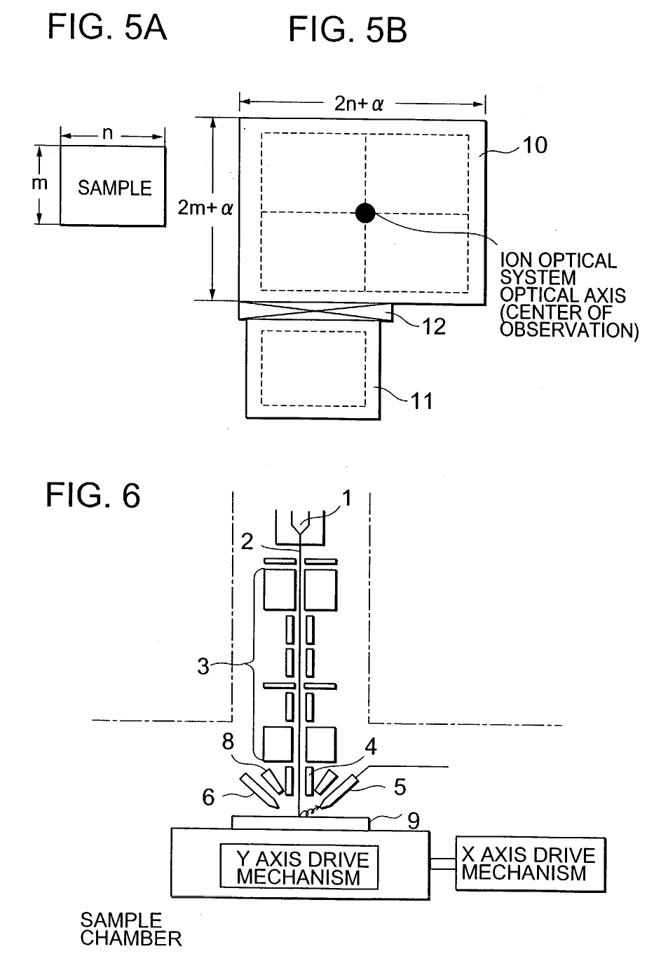

Summarizing the above described test, in order to satisfy the irradiation conditions for all of the regions I, II, III and IV, an off-center position of the ion beam is at a location separated from one corner of the sample chamber by at least the extent of a longer side of respective rectangular samples, and at a position separated by at least ½ the longer of the rectangular sample from diagonally opposite corners in the X and Y directions, and so the length of the edge of the sample chamber is preferably at least 1.5 times the long boundary of the sample. The planar dimension of the sample chamber in this case is at least 1.5n×1.5n, which means that corners are not caught in rotation of a sample having a maximum radius of √2*n as long as the axis of rotation of the stage is in the center of the sample chamber. This situation is illustrated by a rotation mechanism fitted in the sample chamber of FIG. 3.

The above described situation is a sample rotation mechanism provided in a sample chamber, namely, carrying out rotation by driving the stage. In this case, a drive mechanism for performing two dimensional movement in the X and Y directions is required on the stage, and so there is a problem that if another rotation mechanism is added to this stage the mechanism becomes large. Therefore, in another aspect of the present invention, by carrying out rotation of the sample outside the sample chamber, making the stage drive mechanism complicated is avoided, and the initial objective is achieved with a simple structure. At the time of changing over irradiation operations for the four divided regions, this embodiment temporarily returns the sample to a auxiliary chamber, and places the sample back in the sample chamber after carrying out a rotation operation, followed by the next irradiation operation. In Fig. 3, a rotation mechanism is fitted in the auxiliary chamber. Compared to the previous embodiment, a rotation mechanism that only expends a small amount of effort in the operation is used only to rotate a sample mounting platform of the auxiliary chamber and can be made extremely simple. There is also a danger of the degree of vacuum inside the sample chamber dropping due to opening of a gate valve 12 between the sample chamber and the auxiliary chamber, but compared to the sample chamber linking to the ion optical system parts the volume of the auxiliary chamber is as small as required to house the sample, which means that less time is required to restore the vacuum and there is little disadvantage impacting on the operation.

Embodiment 1

One embodiment of the present invention will now be illustrated. This is an example of a focused ion beam device for performing defect correction of a photo mask measuring 1100 mm×1100 mm. A positional relationship between an ion optical system supporting the sample chamber 10 and the auxiliary chamber 11 is as shown in FIG. 2, a rotation mechanism is provided in the auxiliary chamber 11, a sample stage inside the sample chamber 10 is driven in three dimensions, having Z axis direction drive in additional to X, Y drive, and the size of the periphery of the sample chamber 10 is designed to be 1.5times the longer length of the sample +50 mm. The sample in this case is a square, and so the long length and the short length are both 1100 mm, so the size of the sample chamber becomes 1700 mm×1700 mm. The position of the optical axis of the ion beam optical system is located at a location 1125 mm in the X and Y directions with one corner of the rectangular sample chamber 10 as an origin, the size of the auxiliary chamber is made 1600 mm×1600 mm taking a clearance for the dimension between diagonally opposite corners of the sample, and a rotation mechanism is fitted on the sample mounting platform.

A mask repair operation using the device of this embodiment will now be described with reference to the flowchart of Fig. 4. First of all, coordinate information representing the position of a defect on the sample is obtained using a defect checking device before executing mask repair using this device. When mounting this sample on the sample mounting platform in the auxiliary chamber, it is mounted so that a region where a defect exists is moved towards a position where the ion optical system is positioned off-center in the sample chamber when the sample is divided into four regions I, II, III and IV, as shown in FIG. 1. This is because with the present invention, it is not possible to carry out ion beam irradiation for the entire sample surface with a single processing step. The orientation of the sample when mounted on the sample mounting platform of the auxiliary chamber is exactly the same as the mounting orientation of the sample of the sample stage of the sample chamber. Depending on the mounting orientation of this sample, position information of a defect section on the stage varies, and accompanying this, the defect section position information is required to conform to position information for the stage in the sample chamber, and differing from the related art device, the present invention requires this additional processing. With this embodiment, there are four mounting states achieved by rotating and mounting the sample 90° at a time, and a coordinate conversion program matching previously obtained defect coordinate information to respective mounting states is prepared. Once this coordinate conversion is completed, it is possible to specify ion beam irradiation corresponding to movement of the stage in the same way as the related art focused ion beam device.

The gate valve 12 is opened, the sample is caused to move above the stage inside the sample chamber, and positioning (alignment) on the stage is carried out. The gate valve 12 is then closed and the stage is moved so that the defect section is located at the ion irradiation position. Naturally, this stage drive information will be based on position information taken in to coordinate conversion information in response to previous sample orientation. Defect correction (etching or deposition) is executed at a positioned place. When there is another defect in these four divided regions, the stage is moved to the appropriate position and defect correction is performed. Once defect correction at that region is complete, the gate valve 12 is opened and the sample returned to the auxiliary chamber. The rotation mechanism of the sample mounting platform in the auxiliary chamber is driven and rotated and positioned so that a region where a defect exists comes to a position where the ion optical system is located off-center. Using rotational angle at this time as coordinate conversion information, a defect position is calculated as coordinates for the stage at the time of the subsequent operation. After that, in the same way as for the operation of the previous regions “alignment” is carried out, “movement to defect coordinates” is performed, and “correction of defect” is carried out. Once processing has been completed for all regions where there are defects, the series of operations ends.

In this way, with this embodiment it is possible to perform defect correction of a photo mask measuring 1100 m×1100 mm using a focused ion beam device that would have required a sample chamber of about 2250 mm×2250 mm in the related art using a sample chamber that measures only 1700 mm×1700 mm.

### INDUSTRIAL APPLICABILITY

The focused ion beam device of the present invention has an ion optical system arranged so that an irradiation center position of the ion beam comes to a place eccentric in a direction of one corner from a center of a rectangular sample chamber, and is provided with a mechanism for rotating the sample in a direction of the optical axis of the ion optical system, which means that by simply two-dimensionally scanning a sample stage in the X and Y directions, all regions of a sample surface that are impossible to cover can be irradiated by the ion beam by adding an action of sample rotation, and in this way it is possible to process and observe a sample that is large compared to the sample chamber.

Also, when a mechanism for rotating the sample is provided in a auxiliary chamber, a drive mechanism provided on the sample stage inside the sample chamber is only required to move in the X, Y and Z directions and it is possible to restrict increase in size of the sample chamber.

Restricting increase in size of this device simply overcomes problems with respect to size of the sample chamber, and there is no need for a large vacuum device, corresponding to the volume of the sample chamber, which is very significant with respect to cost and also operating efficiency to maintain a vacuum state.

1. A focused ion beam device, having an ion optical system arranged so that an irradiation center position of an ion beam comes to a location off-center in a direction of one corner from a center of a rectangular sample chamber, and provided with a mechanism for rotating a sample around an axis in a direction of an optical axis of the ion optical system.

2. The focused ion beam device of claim 1, wherein:
an off-center position of the ion beam is at a location separated from one corner of the sample chamber by at least the extent of a longerside of respective rectangular samples, and at a position separated by at least ½ a longer side of the sample from the diagonally opposite corner in the X and Y directions; and
the sample chamber is a square with sides at least 1.5 times the long boundary of the sample.

3. The focused ion beam device of claim 2, wherein a mechanism for rotating the sample is provided in the sample chamber.

4. The focused ion beam device of claim 2, wherein a mechanism for rotating the sample is provided in a auxiliary chamber.
